(19) United States
(12) Patent Application Publication
(10) Pub. No.: US 2015/0117201 A1
(43) Pub. Date: Apr. 30, 2015

(54) DATA TRANSMISSION SYSTEM FOR NETWORKS WITH NON-FULL-DUPLEX OR ASYMMETRIC TRANSPORT

(71) Applicant: Saratoga Data Systems, Inc., Saratoga Springs, NY (US)

(72) Inventor: Robert Cousins, Saratoga, CA (US)

(73) Assignee: Saratoga Data Systems, Inc., Saratoga Springs, NY (US)

(21) Appl. No.: 14/065,025

(22) Filed: Oct. 28, 2013

(51) Int. Cl. H04L 12/863; H04L 12/819; H04L 12/26

(52) U.S. Cl. CPC H04L 47/621; H04L 43/0829; H04L 43/0852; H04L 47/21
USPC 370/235

(57) ABSTRACT

A data transfer method and system are provided for networks having gateway-mediated asymmetric transport. Separate data and feedback channels are established between sender and receiver units, along with a gateway feedback channel between a gateway and the sender. The sender transmits datagrams to the gateway in temporal chunks corresponding to the asymmetric transport's timing to keep the gateway's buffer at an optimum fill for maximal throughput without transmit-end packet drops. The receiver acknowledges those datagrams that have been successfully received and identifies any missing or corrupt datagrams. At least some messages include timing information indicative of network latency and congestion. The sender resends datagrams identified as missing or corrupt. The sender self-tunes its transmission rate in reaction to changing network conditions, based upon gateway buffer fill, network latency and datagram loss rate to keep datagram loss rate below a specified upper bound.

### TECHNICAL FIELD

The present invention relates to data transfers between sending and receiving devices in a networked environment, and in particular to such transfers where the underlying transport has non-full-duplex (e.g., half duplex) or other asymmetric characteristics.

### BACKGROUND ART

Packet switched or network communications can be proxied through a gateway into an ‘alien’ transport, such as a half-duplex radio link or a high latency satellite connection, whereby the transport characteristics are modified away from the traditional full duplex communications commonly used for TCP/IP networks. Many existing communications protocols like TCP/IP already suffer from transfer rate limitations due to network latency, traffic congestion and dropped datagrams or packets. Even though the gateways that manage half duplex transport use buffers intended to maintain the illusion of full duplex communication for the sender and receiver, the existence of asymmetric transport tends to increase latency and worsen the problem of dropped datagrams or packets.

In U.S. Pat. No. 8,310,920 to Goldfein et al., a system and method are disclosed that accelerate data transfers over a network even in the face of high latency and congestion. The sender will send as much data as it can as rapidly as possible so as to make maximum use of the available bandwidth. This is in contrast to any specific amount of bandwidth that the network or any of its nodes might attempt to allocate to any given sender. The sender sends datagrams continuously (with only small amounts of inter-datagram delay between contiguous datagrams) until the source of data is exhausted or until the sender is paused by the receiver. The sender thereby floods the transmission channel with traffic, taking all available bandwidth, with the aim of keeping the channel as full of data as possible so that there is always data ready for immediate acceptance by the receiver, even if the extra burden results in some dropped data that must subsequently be resent.

In addition to the data transmission channel, a separate feedback channel is also established between sender and receiver for reporting of synchronization messages (SYNs), acknowledgement messages (ACKs) and negative acknowledgments (NAKs) by the receiver, so the sender can determine network latency and the existence of any lost or corrupted datagrams that need to be resent. Periodic SYNs, as well as ACKs that supplement, replace or incorporate such SYNs once data transmission has begun, include a timestamp, and changes in timestamp differences are used by the sender as a measure of overall latency and network congestion to serve as one basis for tuning the data transmission rate. The sender tries to optimize the use of the available bandwidth capacity as defined by the bandwidth delay product. An optimum rate is defined as the highest rate the data can be transmitted and be successfully received and processed by the receiver with minimum data loss. The content of NAKs and ACKs allow the sender to determine the datagram loss rate in the data channel to serve as another basis for tuning the data transmission rate. Too little loss (or corruption) implies that datagrams can be sent more frequently, while too much loss results in too much retransmission. Hence an optimum data rate can be maintained by the sender setting an upper bound to the datagram loss rate.

In spite of the overall improvement in data transfer provided by the '920 patent's “Flume” protocol, the possible existence of asymmetric transfer conditions invites further enhancements to take account of non-full-duplex throughput via a buffered gateway. During transmission periods of the asymmetric transport, the gateway's buffer will fill as the sender maximizes use of the available bandwidth. Peak throughput occurs when the buffer is close to being full. During back haul periods when the transport is not transmitting to allow traffic in the reverse direction, the gateway buffer will fill at a faster rate and will likely become completely full such that datagrams must be dropped before any can be transmitted. When the transport returns to a transmitting period, the buffer is already full so that datagram drops will continue if the sender continues to supply datagrams at the same high rate. Overall, the effective throughput under such asymmetric transfer conditions is poor due to the predominance of so many datagram losses and the constant need for re-transmittal.

### SUMMARY DISCLOSURE

A network transmission system can optimize data transfer rates if the sender is informed of the existence and timing characteristics of any non-full-duplex or otherwise asymmetric transport in the established data channel. Using that information, the sender will send datagrams to the gateway in temporal chunks corresponding to that transport's timing. Additionally, a feedback channel can be established not only with the ultimate receiver but also with the intervening gateway to keep the gateway buffer at an optimum fill for peak throughput while minimizing dropping of datagrams by the gateway. Where the feedback channel also passes through asymmetric transport, a longer timeout period for acknowledgements can be established based on the transport's timing characteristics. Accordingly, a method is provided for transferring data between a sender and a receiver in a datagram-based network having asymmetric transport characteristics.

The method begins by establishing separate data and feedback channels over the network between the sender and the receiver, where at least a portion of one or both of the channels includes non-full-duplex or asymmetric transport mediated by a gateway in the network. The established channels also include a gateway feedback channel between the gateway and the sender. If the established receiver feedback channel passes through the asymmetric transport used by the established data channel, the receiver and gateway may share that feedback channel. However, the receiver feedback channel, being separately established and distinct from the data channel, need not pass through the asymmetric transport used by the data channel.

Datagrams are sent over the data channel from the sender to the receiver until a source of data is exhausted or paused by the receiver. Groups of datagrams are sent in temporal chunks corresponding to timing characteristics of the asymmetric transport (communicated via gateway feedback, third party feedback or based upon supplied information). The chunks are sent at a rate that keeps a buffer of the gateway at an optimum fill maximal throughput without transmit-end packet drops.

The receiver sends messages over the (receiver) feedback channel to the sender. The messages acknowledge those datagrams that have been successfully received and also identify any missing or corrupt datagrams. At least some messages further include timing information indicative of network latency and congestion. For example, each datagram may include an assigned sequence number indicating an order in which it has been derived from source data. In that case, periodic acknowledgment messages (ACKs) can report the highest consecutive sequence number of the datagrams successfully received to date. Likewise, whenever a datagram is received out of sequence or is found to be corrupt, corresponding negative acknowledgment messages (NAKs) will notify the sender of those sequence numbers of missing or corrupt datagrams not yet successfully received. Based on the messages obtained over the receiver feedback channel, the sender will resend datagrams over the data channel that have been identified as missing or corrupt.

The sender also self-tunes the sending or transmission rate of the chunks of datagrams in reaction to changing network conditions. The self-tuning will be based upon a combination of information about gateway buffer fill, network latency and datagram loss rate, as determined from the content of messages received over the feedback channels. The self-tuning is adapted to at least keep datagram loss rate below a specified upper bound, while still trying to keep the gateway buffer at or near its optimal fill level during both transmitting and back haul periods of the asymmetric transport.

### BRIEF DESCRIPTION OF THE DRAWINGS

FIG. 1 is a schematic block diagram illustrating typical components of a data transmission system and network containing asymmetric transport over at least a portion of a data transmission pathway, which forms both the context and basic elements of the present invention.

FIG. 2 is a timing diagram illustrating prior art data transmission over a network like that in FIG. 1 but without the elements of the present invention.

FIG. 3 is a block flow diagram illustrating steps carried out by a data transmission system in accord with the present invention.

FIG. 4 is a timing diagram, like that of FIG. 2, but illustrating data transmission over a network like that in FIG. 1 with the elements of a data transmission system in accord with the present invention.

### DETAILED DESCRIPTION

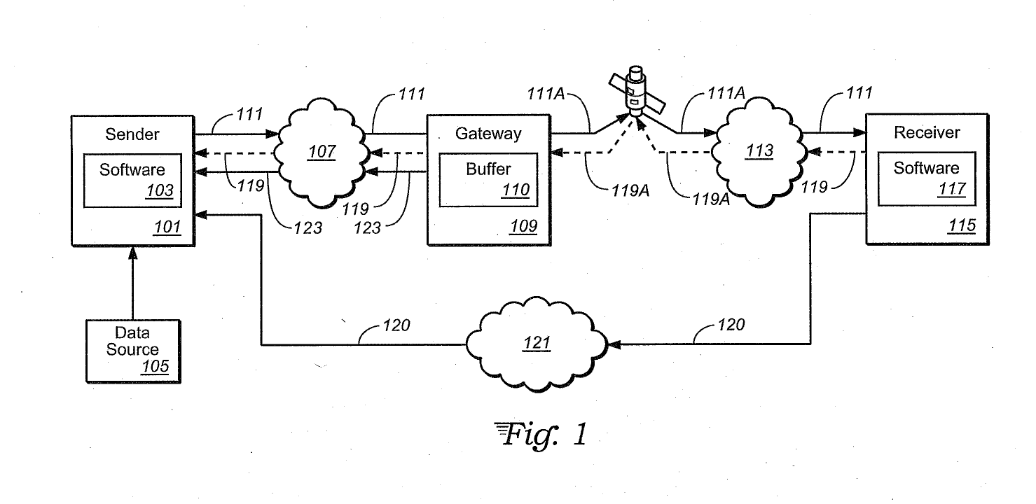

With reference to FIG. 1, a data transmission system couples a sender 101 to a receiver 115 for data transfer over a network 107, 113 and 121. Sender 101 and receiver 115 have software, 103 and 117 respectively, loaded on their computer hardware for implementing a data transfer protocol in accord with the present invention. The sender 101 has access to a data source 105 storing data that may be transferred over the network in response to a request from the receiver 115.

A data channel 111 is established between the sender 101 and receiver 115 over some available pathway 107, 113 of the network. The data channel 111 is seen here to include a portion 111A with asymmetric (e.g., non-full-duplex) characteristics, such as a radio or satellite link. Such asymmetric characteristics are alien to the full-duplex data transfer characteristics typically used in data networks via TCP/IP or similar protocols. This asymmetric portion 111A of the data channel 111 is mediated by a gateway 109 that allows buffering of data with a buffer 110 so that the asymmetric portion 111A of the data channel will be as transparent as possible to data transfer operations.

In addition to a data channel 111, a separate feedback channel 119 or 120 is established between the receiver 115 and sender 101. The feedback channel 119 may use the same asymmetric pathway 119A as the data channel portion 111A or may be directed along a different pathway 120 of the network that does not have any asymmetric characteristics. In the present invention, the sender 101 makes use of timing characteristics of the asymmetric portion 111A of the data channel. These timing characteristics, as well as information about gateway buffer fill levels, are provided by the gateway 109 to the sender 101 via a gateway feedback channel 123, which could be separate from the receiver feedback channel 120 or could share the same feedback channel 119 as receiver 115.

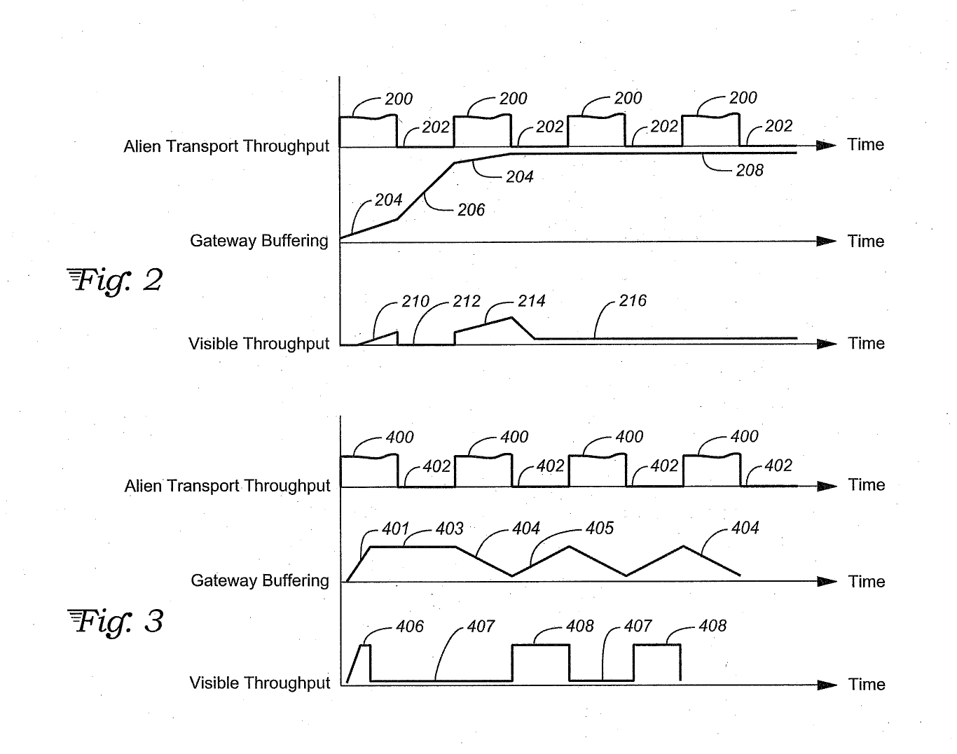

With reference to FIG. 2, if data transfer were to be carried out according to prior art transfer protocols, the timing through the gateway and asymmetric portion of the data channel would typically take place as shown. In particular, the gateway manages half-duplex transport and buffer reverse traffic in such a way as to maintain the illusion of full duplex communications. When a sender begins to transmit data over an established data channel of the network, the gateway's buffer ideally should fill during back haul periods and empty during transmitting periods of the asymmetric transport portion. However, under conditions where a sender is operating under more aggressive transfer protocol, such as “Flume”, which is described in the aforementioned U.S. Pat. No. 8,310,920, it may be difficult for the sender to self-tune the data sending rate to keep loss of datagrams below a specified rate. To understand this, the top line of FIG. 2 shows the regularly alternating transmitting periods 200 and back haul periods 202 of data transfer through the asymmetric transport portion of the data channel. The second line of FIG. 2 shows the buffer fill level of the gateway buffer. It can be seen that under aggressive transport protocols the buffer fills both during the back haul and transmit periods 202 and 200. It simply fills more slowly during transmit periods, as shown where indicated by reference numeral 204, and more rapidly during back haul periods as indicated by reference numeral 206. Fairly quickly, the buffer becomes completely full (at 208), such that continually arriving datagrams cannot be handled and must be dropped from the buffer. The bottom line in FIG. 2 shows the apparent throughput observed by the sender through ACK and NAK messages obtained as feedback from the receiver. Throughput rises during initial transmit periods 210 as the buffer begins to fill, is of course zero during back haul periods 212, and peaks during transmit periods 214 when the buffer is close to, but not completely, full (i.e., near an optimum fill level). However, once the gateway buffer is completely full and is forced to drop datagrams in one or more subsequent back haul periods, effective throughput is seen by the sender to be close to zero even during transmit periods 216 because dropped datagrams begin to be reported as missing when datagram discards become predominant. The sender spends more time filling resend requests than it does sending new datagrams.

The aggressive “Flume” data transfer protocol is here modified and extended to better function in the specific environment where the underlying transport is half duplex or has asymmetric characteristics. The modifications and extensions allow a sender 101 to synchronize its transmissions over the data channel 111 and 111A with the buffering in the gateway 109 such that datagrams are not discarded. There are several ways in which this goal is accomplished:
“Chunking” of datagrams into groups and temporarily separating chunk transmission.
Use of feedback from gateway to control EF's transmission rate.
Use of more global feedback from alien transport to control transmission rate.

Furthermore, the delays involved in such an alien transport may cause some datagrams to appear to be unacknowledged for very long periods of time. There are several ways to address this including:
Basing ‘timeout’ upon knowledge of the alien transport's timing characteristics
Redefining the concept of a dropped datagram so as to be based upon the chunking.
Adding protocol support to reserve resources at the gateways such that buffering will never be overrun.

The retransmission schedule for EF could be modified so as to place retransmitted datagrams at the beginning of each transmit period in order to minimize memory consumption on the receiver.

With reference to FIG. 3, data transfer between a sender unit at a first endpoint of a datagram-based inter-network and a receiver unit at a second endpoint in the datagram-based network begins by establishing separate data and feedback channels over the network between the sender and receiver (step 301). Both sender and receiver cooperate in establishing such channels and, until such time as the data transfer session is complete, both sender and receiver units remain coupled to those established channels. Each channel comprises at least one path over the network.

While inter-networks typically employ full duplex communication, it may occur that some portion of a path on one or both of the established channels includes a non-full-duplex or otherwise asymmetric transport characteristic, such as communication over a radio or satellite link, which is mediated via a gateway in the network. Accordingly, once the channels are established, the sender unit endeavors to determine whether or not there is such a gateway in the network path of either or both channels (step 302). A gateway cannot be 100% transparent in all measurable dimensions. Instead, a gateway's purpose is to preserve transparency along well established or primary dimensions. The sender unit can determine the presence of a gateway by simply noticing a change in secondary characteristics of an established channel. An example of this is with a virtual private network (VPN), which though largely transparent, typically comes at the price of performance and often with a change in the maximum transmission unit (MTU) for the virtual network.

Accordingly, if the determination is that there is no gateway or asymmetric transport portion in either established channel, data transmission can proceed (e.g., step 307) according to an existing protocol (such as the Flume protocol described in U.S. Pat. No. 8,310,920 described above). Likewise, if only the feedback channel passes through such a pathway of the network, it is of little consequence and an existing protocol can likewise be employed, if desired.

On the other hand, if the data channel or both channels pass through a gateway mediating asymmetric data transfer, certain information will be required of the gateway for the sender unit to implement the present invention. Accordingly, either the same or a different feedback channel will be established between the sender and gateway for obtaining such information. If the already established feedback channel already passes through the gateway, such channel can be allowed to be shared with the gateway (step 303). If the established feedback channel does not pass through the gateway (since it is separately established it may have a different path through the network than the data channel), a separate gateway feedback channel will be established (step 304) in addition to the already existing receiver feedback channel.

Timing characteristics of the asymmetric transport portion of the channel(s) are communicated by the gateway to the sender unit (step 305). Such timing characteristics may include information regarding the respective time durations of alternating transmit and back haul periods of the asymmetric transport, synchronization information such as latency from sender to gateway, and latency through the asymmetric transport. The information can take many forms—from media access control (MAC) level flow control information to simple network management protocol (SNMP) management information base (MIB) information which indicates the gateway device's configuration. As there is currently no standard, and we cannot assume that the gateway is running any software specific to the present protocol, the sender unit must be sufficiently resourceful so as to be capable of recognizing the various possible forms of communicated timing characteristics. While we can foresee the possibility in the future of an intermediate node having software specific to the protocol and functioning like a gateway, at present the protocol works best when the sender and receiver units are the only nodes in the established channel pathways of the network that are cognizant of the gateway's existence.

The sender unit proceeds to send datagrams over the data channel to the receiver unit until a source of data is exhausted or until paused by the receiver. Where, as here, the data channel includes an asymmetric transport portion mediated by a gateway, the datagrams are sent in temporal chunks corresponding to the timing characteristics of the asymmetric transport (step 306). Thus, chunks of datagrams will only be sent for a duration corresponding to the transmit period of the asymmetric transport and then be dormant for a duration corresponding to the back haul period. Synchronization of the sending can lead the transmit period such that the gateway buffer is already optimally filled when each transmit period starts. It is possible to develop a timing-based relationship analogous to a phase-locked loop. If there is MAC-level feedback, then the sender unit can allow the gateway to tune the relationship. If there is no explicit feedback, the sender unit can use higher-level analytical tools to identify patterns to data drops. Consistent gateway buffer overflows will result in predictable lost datagrams. The period and number of these losses, as reported by NAKs from the receiver unit, will provide the required feedback information, which when analyzed allow the sender unit to adjust the timing of its transmissions so as to avoid these predictable losses.

When receiving feedback from the gateway, the gateway buffer fill level (which may also include a measure of remaining gateway buffer space) is periodically communicated to the sender (step 308). In this way, the sender unit can self-tune the sending rate in order to keep the gateway buffer at or near an optimum fill to minimize dropping of datagrams and make full use of each transmit period.

The receiver unit identifies received datagrams and regularly reports successful receipt of datagrams to the sender by means of periodic acknowledgement messages (ACKs). The receiver also identifies any missing or corrupt datagrams not successfully received and, as needed, sends negative acknowledgments (NAKs) to the sender over the established feedback channel. (Step 309) For example, one manner in which datagram transmission and receipt can be tracked involves assigning of sequence numbers to datagrams according to the order in which they have been derived by the sender from source data. Periodic ACKs from the receiver report the highest consecutive sequence number for datagrams received to date. With such ACK information, the sender unit need only retain those sent datagrams in a condition available for immediate resending that have not yet been acknowledged. Once an ACK message acknowledges successful receipt, those datagrams with sequence numbers less than or equal to the reported sequence number can be removed from a sender buffer. Likewise, sequence numbers allow a receiver to identify those datagrams that are received out of order with intervening missing datagrams, and to identify any datagrams which arrive corrupted. A NAK message reports the identity of missing or corrupted datagrams that need to be resent. Whenever the sender determines that a NAK message has been received (step 310), the sender immediately resends those datagrams identified in that NAK (step 311) in the next datagram chunk (step 306).

The sender regularly self-tunes the sending rate in reaction to changing network conditions. Such self-tuning is based upon a combination of factors, including gateway buffer fill (to maintain the fill level at an optimum level), network latency and datagram loss rate (to maximize use of available bandwidth). These factors are determined from the content of the messages received over the receiver feedback channel and gateway feedback channel, whether separate or shared. Thus, network latency may be determined from timing information reported back on periodic SYN messages or in ACK messages. (For example, sent datagrams may have a sender timestamp and their arrival time recorded by the receiver. Changes in the time difference can then be reported. Alternatively, if the feedback channel uses the same network pathway as the data channel, the SYN and ACK messages themselves may be time-stamped.) Datagram loss rate, from any source—including any drops by the gateway buffer—can be determined from arriving NAK messages. The sender's self-tuning of the data send rate is adapted to at least keep a datagram loss rate below a specified upper bound.

There are two classes of adaptations of the self-tuning due to the presence of asymmetric transport in the channels: symmetric timing and asymmetric timing. In symmetric timing (analogous to a stoplight), the sender unit simply has to wait its turn to transmit to avoid overfilling the gateway's transmit buffer. In asymmetric timing, we model the amount of transmit time required versus the receive time so that we can allocate the optimal amount of time. (In this latter case, the receiver unit has every reason to keep its reply windows small so that there will be no wasted reply time in the gateway.)

The sender (and receiver) units can adapt to the inherently long latencies in many asymmetric transports by lengthening the timeout period according to the timing characteristics information received from the gateway (step 305). This will prevent either unit from giving up prematurely on receipt of datagrams or of ACK messages from the other unit at the endpoints of the established channels.

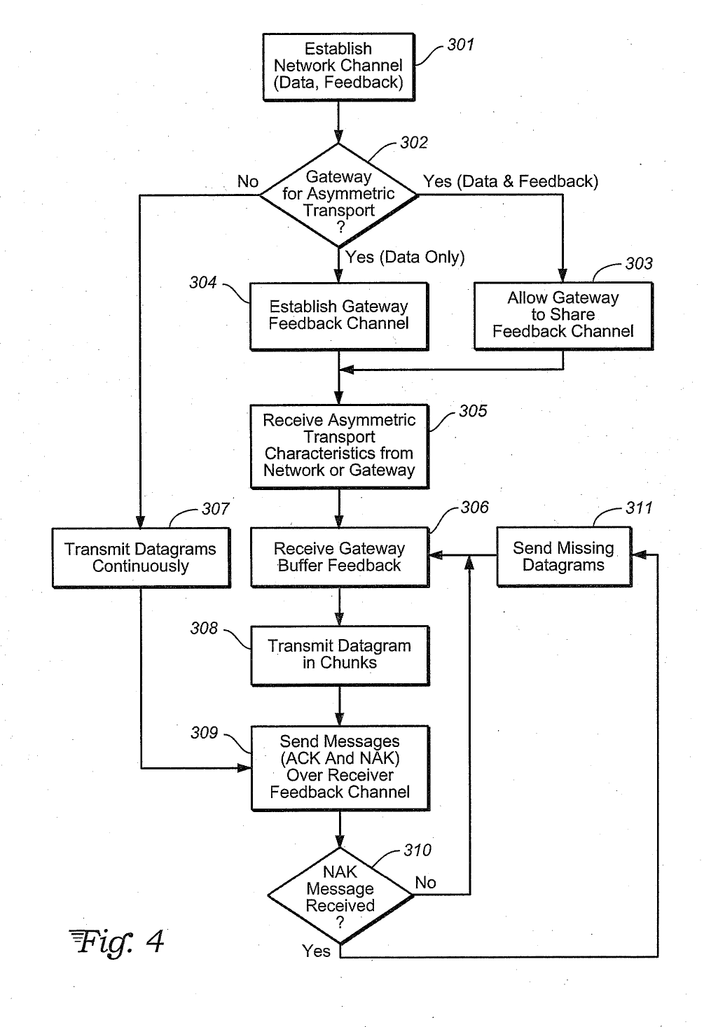

With reference to FIG. 4, the first row shows the asymmetric transport throughput with alternating transmitting and back haul periods 400 and 402. This is the same as in FIG. 2. During transmit periods 400 the gateway allows only outgoing transmissions, while during the back haul periods 402 the gateway allows only incoming transmissions. The second row shows the gateway buffering level when the present invention is implemented. During the initial transmit period 401 the gateway buffer is filled quickly. The buffer remains full (at 403) during the remainder of the transmit period and the subsequent back haul period until transmission is again allowed. The buffer drains slowly during transmission period 404 and may be at or near empty at the end 405 of the transmit window. It will subsequently refill and drain cyclically. Note that the buffer does not become completely full, thereby avoiding dropping of datagrams. The third row shows the overall throughput of data as seen by the sender. At the beginning 406, the sender unit transfers one buffer full of data quickly. Then, it waits (during period 407) for the buffer to empty. The sender periodically quickly refills the buffer (during periods 408) with intervening wait periods. Depending on the latency between the sender and gateway, the transmit periods 408 of the sender unit need not coincide exactly in time with either transmit or back haul periods 400 or 402 of the gateway, but once established, a cyclical transmission pipeline will tend continue until the source of data is exhausted. Due to changing network conditions, the sender unit will continually self-tune Or adjust its transmission timing, so the cycles (407 and 408) will usually not be precisely periodic.

What is claimed is:

1. A method of transferring data between a sender and a receiver in a datagram-based network, comprising:
establishing separate data and feedback channels over the network between the sender and receiver, at least a portion of one or both of the channels including non-full-duplex or asymmetric transport mediated by a gateway in the network, the established channels also including a gateway feedback channel between the sender and the gateway;
sending datagrams over the data channel from the sender to the receiver until a source of data is exhausted or paused by the receiver, the datagrams being sent in temporal chunks corresponding to timing characteristics of the asymmetric transport, the chunks being sent at a rate that keeps a buffer of the gateway at an optimum fill as determined by feedback from the gateway;
sending messages over the feedback channel from the receiver to the sender acknowledging datagrams that have been successfully received and identifying any missing or corrupt datagrams, the messages further including timing information indicative of network latency and congestion;
resending datagrams over the data channel that have been identified as missing or corrupt; and
self-tuning by the sender of the sending rate in reaction to changing network conditions based upon a combination of gateway buffer fill, network latency and datagram loss rate as determined from the content of the messages received over the receiver feedback channel and gateway feedback channel, the self-tuning adapted to at least keep a datagram loss rate below a specified upper bound.

2. The method as in claim 1, wherein the receiver feedback channel is established through the asymmetric transport mediated by the gateway, and the receiver and gateway share the receiver feedback channel such that the gateway feedback channel is the same as the receiver feedback channel.

3. The method as in claim 1, wherein the receiver feedback channel does not pass through the asymmetric transport used by the established data channel.

4. The method as in claim 1, wherein each datagram includes an assigned sequence number indicating an order in which it has been derived from source data, the messages from the receiver including periodic acknowledgements (ACKs) reporting the highest consecutive sequence number of datagrams successfully received to date.

5. The method as in claim 4, wherein the messages from the receiver further include, whenever a datagram is received out of sequence or is corrupt, corresponding negative acknowledgements (NAKs) notifying the sender of sequence numbers of missing or corrupt datagrams not yet successfully received.

6. A system of transferring data between a sender at a first endpoint and a receiver at a second endpoint in a datagram-based inter-network, the system comprising:
a data channel configured to transmit datagrams over at least one path of the inter-network;
a feedback channel separate from the data channel and configured to transmit messages over the inter-network, the messages including acknowledgement messages (ACKs) that acknowledge successful receipt of datagrams and negative acknowledgements (NAKs) that identify any missing or corrupt datagrams, at least some messages periodically including timing information indicative of network latency and congestion;
a gateway in at least one path of least the data channel in the inter-network, the gateway configured to mediate non-full-duplex or asymmetric transport of datagrams over the at least one path, the gateway having a buffer for datagrams transmitted over the data channel, the gateway further configured to provide timing characteristics of the asymmetric transport and report a buffer fill level over the same or a different feedback channel;
a sender unit coupled to the data channel and the feedback channel, the sender configured to establish the respective channels, send datagrams over the data channel to the receiver until a source of data is exhausted or paused by a receiver unit, and resend any datagrams identified as missing or corrupt, the datagrams being sent in temporal chunks corresponding to timing characteristics of the asymmetric transport, the chunks being sent at a rate that keeps a buffer of the gateway at an optimum fill as determined by feedback from the gateway, the sender also configured to self-tune the sending rate of chunks of datagrams in reaction to changing network conditions to optimize throughput based upon a combination of gateway buffer fill, network latency and datagram loss rate as determined from the content of the messages received over the receiver feedback channel and gateway feedback channel, the self-tuning adapted to at least keep a datagram loss rate below a specified upper bound; and
a receiver unit coupled to the data channel and the feedback channel, the receiver configured to establish the respective channels with the sender unit, to receive datagrams over the data channel, send both ACK messages at predetermined intervals and NAK messages as needed to the sender over the feedback channel.

7. The system as in claim 6, wherein the feedback channel is established through the asymmetric transport mediated by the gateway, and the receiver unit and gateway share the feedback channel.

8. The system as in claim 6, wherein the feedback channel does not pass through the asymmetric transport used by the established data channel and a separate gateway feedback channel is also established over the inter-network between the gateway and sender unit.

9. The system as in claim 6, wherein each datagram includes an assigned sequence number indicating an order in which it has been derived from source data, the periodic acknowledgement messages (ACKs) from the receiver unit reporting the highest consecutive sequence number of datagrams successfully received to date, the sender unit configured to track sent datagrams and to retain the sent datagrams available for resending until acknowledged by an ACK message.

10. The system as in claim 9, wherein the messages from the receiver unit further include, whenever a datagram is received out of sequence or is corrupt, corresponding negative acknowledgements (NAKs) notifying the sender unit of sequence numbers of missing or corrupt datagrams not yet successfully received, the sender unit configured to resend, as part of one or more chunks, those datagrams that have been identified by a NAK.
